(19) United States
(12) Patent Application Publication
(10) Pub. No.: US 2024/0160160 A1
(43) Pub. Date: May 16, 2024

(54) Method and System for Industrial Change Point Detection

(71) Applicant: ABB Schweiz AG, Baden (CH)

(72) Inventors: Ruomu Tan, Mannheim (DE); Marco Gaertler, Dossenheim (DE); Benjamin Kloepper, Mannheim (DE); Sylvia Maczey, Hirschberg (DE); Andreas Potschka, Goslar (DE); Martin Hollender, Dossenheim (DE); Benedikt Schmidt, Heidelberg (DE)

(73) Assignee: ABB Schweiz AG, Baden (CH)

(21) Appl. No.: 18/455,340

(22) Filed: Aug. 24, 2023

Related U.S. Application Data
(63) Continuation of application No. PCT/EP2022/054565, filed on Feb. 23, 2022.

(30) Foreign Application Priority Data
Feb. 24, 2021 (EP) 21159046.8

(51) Int. Cl. G05B 13/02

(52) U.S. Cl. CPC G05B 13/027

(57) ABSTRACT

A method for detecting change points, CPs, in a signal of a process automation system, includes, in an offline learning phase, unsupervised, candidate CPs on at least one offline signal using unsupervised detection method are detected, CPs are selected from the candidate CPs; the selected CPs are provided to a supervised process; in the supervised process, an offline machine-learning (ML) system is trained to refine CPs from the selected CPs using a supervised machine learning method; a training data set for an online ML system is created using the offline ML system by projecting the refined CPs on the signal; the online ML system is trained in a supervised manner, using the created training data set; and after the offline learning phase, CPs are detected using the trained online ML system.

### CROSS-REFERENCE TO RELATED APPLICATIONS

The instant application claims priority to International Patent Application No. PCT/EP2022,054564 filed Feb. 23, 2022, and to European Patent Application No. 21159046.8, filed Feb. 24, 2021, each of which is incorporated herein in its entirety by reference.

### FIELD OF THE DISCLOSURE

The present disclosure generally relates to a computer-implemented method for detecting change points, CPs, in a signal, a controller configured to perform the steps of the computer-implemented method, an industrial process system comprising such a controller, and a use of such a controller in an industrial process system.

### BACKGROUND OF THE INVENTION

Online change point detection (CPD) on signal data is a useful data analytics tool for industrial processes. Online CPD can be used in several applications to detect transitions between phases in a batch production process or to detect changes in process behavior automatically in order to inform the operator, or as a pre-processing step for pattern recognition where certain shapes in signals are recognized, such as “drop in steam pressure”.

The selection of a suitable algorithm and its parameterization for unsupervised CPD heavily depends on the characteristics of the data and the use case. Choosing the right algorithms and tuning the parameters is quite tedious. An alternative to unsupervised CPD algorithms is to use supervised CPD algorithms. Often, a human expert needs to provide example change points (and not-change points), and a supervised machine-learning algorithm is trained to classify whether a given data point within a time-series or signal is a change point or not. This effort of labeling the data is very tedious. In some plants, the automation system might record event data that indicates a change in the process behavior (e.g. change of batch phase). However, often this data is unavailable, hard to get or cluttered with noise. In addition, manual steps initiated by human operators are often not recorded. Many continuous monitoring algorithms like state-based alarming depend on the current process state (e.g. startup—half load—full load—shutdown). CPD can be used to determine the current process state. Because of the high human effort for both variants of supervised and unsupervised CPD, CPD algorithms are hardly used in practice.

### BRIEF SUMMARY OF THE INVENTION

The described embodiments pertain to the computer-implemented method for detecting change points in a signal, the controller configured to perform the steps of the computer-implemented method, the industrial process system comprising such a controller, and the use of the controller. Synergetic effects may arise from different combinations of the embodiments although they might not be described in detail.

Further on, it shall be noted that all embodiments of the present invention concerning a method, might be carried out with the order of the steps as described, nevertheless this has not to be the only and essential order of the steps of the method. The herein presented methods can be carried out with another order of the disclosed steps without departing from the respective method embodiment, unless explicitly mentioned to the contrary hereinafter.

Technical terms are used by their common sense. If a specific meaning is conveyed to certain terms, definitions of terms will be given in the following in the context of which the terms are used.

According to a first aspect, a computer-implemented method for detecting change points, CPs, in a signal of an automation system is provided. The method comprises the following steps. In a first step, in an offline learning phase, unsupervised, candidate CPs on at least one offline signal using unsupervised detection method are detected. In a following step, CPs are selected from the candidate CPs. The selected CPs are provided to a supervised process. In a next step, in the supervised process, an offline machine-learning (ML) system is trained to refine CPs from the selected CPs using a supervised machine learning method. In a next step, a training data set for an online ML system is created using the offline ML system by projecting the refined CPs on the signal. In a further step, the online ML system is trained in a supervised manner, using the created training data set. After the offline learning phase, CPs are detected using the trained online ML system.

In more detail, first, offline data from a recorded signal is used as input for the first step of the method that performs the detection of candidate CP out of the signal data. Based on human expert decision, one or a few signals are selected as reference signals. The recorded signal may be a reference signal. A reference signal is supposed to be representative with respect to changes in production process. If a CP is detected on the reference signal, the assumption is that the entire process shows a change in behavior. In the following, the method is described with one reference signal, although the input may comprise more than one reference signals.

The recorded signal is represented as a time-series of samples, so that each sample is associated with a time-point. “Point” in “change point” refers to the time-point of such a sample. The candidate CPDs may thus be offline CPDs in recorded historic data. The samples may be equidistant samples with respect to time and may comprise a signal value and a timestamp.

The detection of possible CP candidates is performed automatically, that is, without labels coming from, for example, human beings or other data sources or systems, that identify a time-point as an actual change point, which is also referred to as “unsupervised”. The detected candidate CPs typically comprise correctly detected and falsely detected CPs. In the next step, algorithms are applied to select CPs, so that the ratio of correct and false CPs is improved. The selected CPS may be provided to a user who verifies and refines the selection of CPs from the previous step. That is, in this training step, the CPs are refined in a supervised manner. This refining is part of a machine-learning process, in which the CPs may be labelled and provided with annotations. “Machine-learning process” may be interpreted in a very broad sense, as several algorithms may be applied, and the learning may also comprise adjusting parameters of an algorithm etc. This training step may be done iteratively until, for example, a change in the ratio of correct and false CPs is lower than a threshold. The machine-learning process of this step is referred to as “training an offline ML system”. Once the offline ML system has been trained, the training data for the online ML system is prepared. The previous step created a label for each ti. This label is used to train a supervised online CPD. Further, the refined CPs are projected on the signal. That is, the produced information with respect to the CPs or non-CPs is, for example, transferred to and completed for each of the samples of the signal, thereby obtaining a so-to-say complete offline training data set, depending on the available or used signal samples. As a next step, the offline training data set is used for training an online ML system. The online ML system differs from the offline ML system, for example, in that in an offline ML system, predictors relating to a point of time before and after a current point of time is available. The online ML system is build-up such, that only predictors relating to a point of time before and equal to the current point of time is available. The training of the online ML is supervised. When the training of the online ML system is finished, this system is applied to the online signal, wherein the online signal may be samples of a signal of a currently running industrial process, i.e., the trained model for online CPD is fed with live data from the industrial process. At each sampling step, the online CPD model will return an information whether the last timestamp was a change point or not.

The method thus provides a combination of unsupervised change point detection (CPD) with active learning and supervised CPD. Due to this combination, supervised CPD change point detection with low labeling effort due to combination of unsupervised CPD and active learning is provided. The computer-implemented method may be applied, for example, in batch phase recognition, process monitoring by CPD, state-based monitoring, process monitoring by anomaly detection or classification, and signal data search.

The production of batches in chemical batch processes are split into a number of distinctive phases. For plant operators, it is critical to know the current batch phase and the start or transition into a new batch phase, because operators need to take specific actions depending on phase information or need to understand the context to monitor the process for instance based on trends. In highly automated batch plants this information is available within the control system. However, in semi-automated batch plants this information is not available from the control system. Furthermore, in a batch monitoring system of third-party vendors, i.e., vendor different to control system vendor, this information might not be available online or at all. Online CPD can be directly applied to identify a transition between batch phases. Knowledge about batch phases allows an alignment of different batches (the length of phases can differ from batch to batch) so that algorithms like Multivariate Principal Component Analysis (MPCA) can be applied which require the same length for each compared batch.

Referring to process monitoring by CPD, changes in the process behavior that are not introduced by operator actions, such as changing actuator values or setpoints, are of high interest to the plant operator and can direct their attention to relevant signals. CPD can be used to detect changes in the behavior of a signal. Combined with additional logic, for example, a check if a matching setpoint or a correlated other process value changed, or a machine-learning model, for example, a classification that classifies intended vs. unintended changes, the online CPD can be used to detect such relevant changes in process behavior.

In state-based monitoring, many models used for monitoring like linear interpolations are only valid for steady state operation in a specific setpoint. CPD can be used to identify the transition between different steady states so that the model can be changed accordingly.

The method can further be applied to detect anomalies or for classification in process monitoring. CPD can be used to cut the otherwise continuous signal into segments with start (a first change point) and end (the next change point) times. These segments can be used as samples in an anomaly detection or in a classification process, which are very cumbersome to train on a continuous signal.

Searching in signal data is a promising support function for plant operators. Performing search efficiently requires some kind of indexing or clustering of the historical data in order to avoid that a search process needs to perform a pass over the entire historical data. Similar to process monitoring by anomaly detection or classification, the CPD is used to split a continuous signal into several meaningful segments. These segments can be compared using an elastic distance measure (e.g., dynamic time-warping, Levenshstein distance after preprocessing with symbolic aggregate approximation) and clustered into groups. Comparison and search now only need to be performed within clusters or against cluster centroids and not against the entire signal history. Consequently, search results can be yielded more quickly with less computational effort.

### BRIEF DESCRIPTION OF THE SEVERAL VIEWS OF THE DRAWING(S)

FIG. 1a shows a first high-level flow diagram of a computer-implemented method for detecting change points, CPs, in a signal of a process automation system according to an embodiment of the present disclosure.

FIG. 1b shows a second high-level flow diagram of the computer-implemented method.

FIG. 2 shows a first part of a detailed flow diagram of the computer-implemented method in accordance with the disclosure.

FIG. 3 shows flow diagrams with active learning methods as parts of the computer-implemented method in accordance with the disclosure.

FIG. 4 shows a second part of a detailed flow diagram of the computer-implemented method in accordance with the disclosure.

FIG. 5 shows a structure of an offline training sample with binary decisions in accordance with the disclosure.

FIG. 6 shows a structure of an offline training sample with annotations in accordance with the disclosure.

FIG. 7 shows a structure of an online training sample in accordance with the disclosure.

FIG. 8 shows a block diagram of the application of ML based offline CPD in accordance with the disclosure.

FIG. 9 shows a block diagram of training ML based online CPD in accordance with the disclosure.

FIG. 10 shows a block diagram of the application of ML based online CPD in accordance with the disclosure.

### DETAILED DESCRIPTION OF THE INVENTION

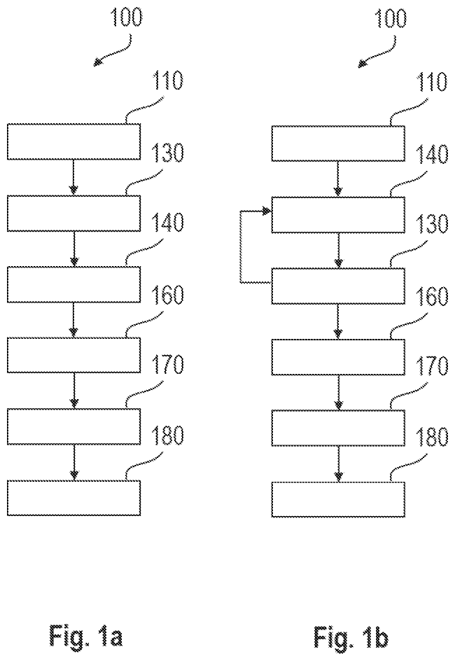

FIGS. 1a and 1b show a high-level block diagram to give an overview of the computer-implemented method 100. In a first step 110, offline CPDs are solved unsupervised. In a second step 130, an active learning of CPD detection is performed using the CPs detected in the first step 110. In a third step 140, the CPs are labelled in a supervised manner. In a fourth step 160, training data is created for online CPD using a model trained in the active learning step. In a fifth step 170, the online CPD is trained with the training data, and in a sixth step 180, online CPs are detected. The steps are explained in detail in the following. FIG. 1b differs from 1b in that, that actually, the active learning 130 starts with a first supervised labeling 140 which is then followed by an initial active learning step, and steps 130 and 140 are repeated until a condition is met.

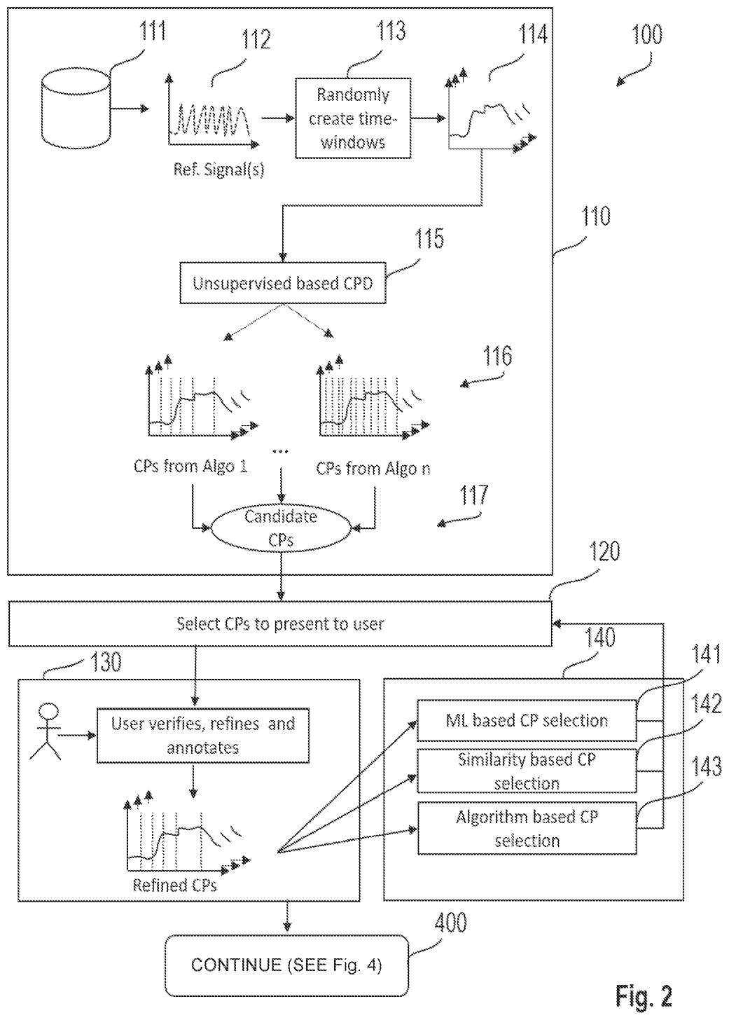

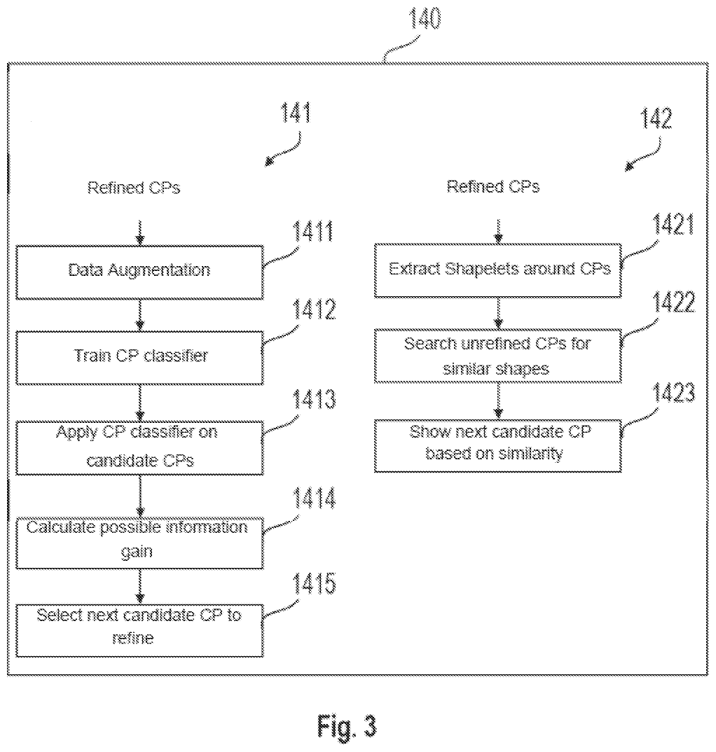

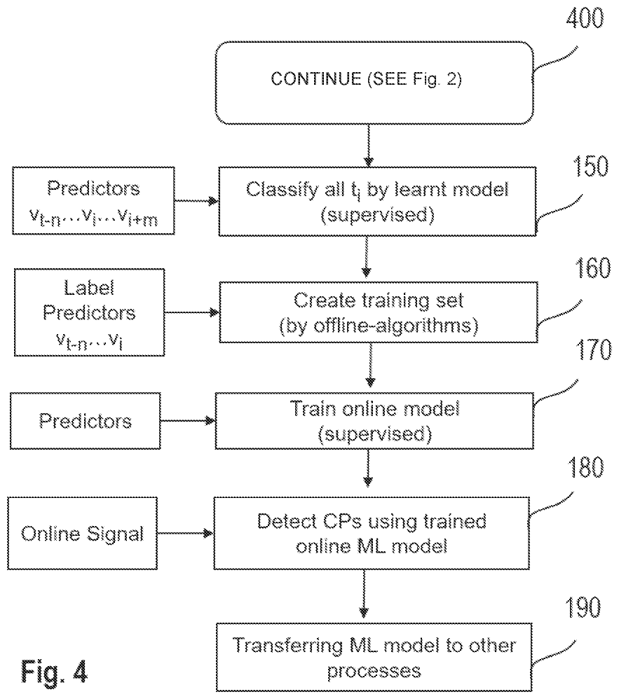

FIG. 2 shows a more detailed of the method 100. Historical data 111 that comprises signal data of several signals of a process is provided as input of the step 110, solving unsupervised CPD. The signal is represented by samples that each comprise a signal value and a time stamp. Out of these signals, one or more signals are selected on human decision as reference signals 112. A reference signal is supposed to be representative w.r.t to changes in production process. Random time windows (113, 114) are created such that samples of several time windows (113, 114) of the one or more signals are filtered out, which form the basis for unsupervised CPD 115, and which are passed to different algorithms 1 . . . n. The algorithms identify 116 candidate CPs 117, which are input to step 120, where CPs are presented to a user. With the identification of the candidate CPs 117, step 110, solving unsupervised CPD, is completed.

In step 120, CPs are selected, that are then presented to the user so that the user can perform the supervised CPD in the subsequent part of the method. The selection may be performed according to one or a combination of the following options.

As a first option, the CPs may be selected randomly out of all candidate CPs. Alternatively, for each algorithm, the CPs random selection is performed in the following way. A sliding time-window is defined which slides inside an internal greater time window. The sliding time window is applied to all algorithms, and all CPs over all algorithms are summed up. The same procedure is performed with further sliding time windows. Those sliding time windows, i.e., the CPs of these windows, are presented to the user that contain a high number of CPs.

In a further alternative, a machine-learning classification is applied, where all the CP candidates or a random sample of all candidates and time-windows without CP candidates is used as input. As an example, the machine-learning classification might be a time-series classification with a recurrent neural network, RNN.

A further method could be to match time stamps of a known or recorded batch with the CPs. Both, matching CPs and not matching CPs could be provided to the user for the subsequent supervised CPD. The user is, for example visually, provided with the information about the matching result so that the supervision is based on or assisted by this information.

A further option may be to compare the candidate CPs of several signals with each other. Often, there is a relationship or correlation between the signals with respect to the CPs.

As a communality, the objective of the selection is to arrive at an initial set of CP candidates, which contains an equal number of samples that the user will likely accept and likely will reject (class balance).

In step 130, the user accepts or rejects the change points that are presented to him. He also gets the possibility to refine the change points (e.g., delete or add a change point, change the position of a change point) and annotate the change point (e.g. change form batch phase A to batch phase B or change from steady state to transition due to load change). The user can also refine the number of detected CPs by tuning the parameters of the CPD algorithm so that the algorithm results in fewer or more CPs. The output of several CPD algorithms can be presented to the user and the user can choose the best one. Finally, the user might add some static rules like, for example: IF two points are in proximity (timestamp of second point—timestamp of first point<threshold) AND the first value is in range [first lower value; first upper value] AND the second value is in range [second lower value; second upper value) THEN a candidate CP should be accepted and should be assigned some label.

After selecting the CPs in step 120, the selected CPs are presented to the user for verifying, refining and annotating the CPs. The refined CPs are provided to an active learning processing 140. This processing 140 may comprise machine-learning based CP selection 141, similarity-based CP selection 142, and/or algorithm based CP selection 143. These examples of active leaning methods have been explained above as “refinement rule options” and are not repeated here.

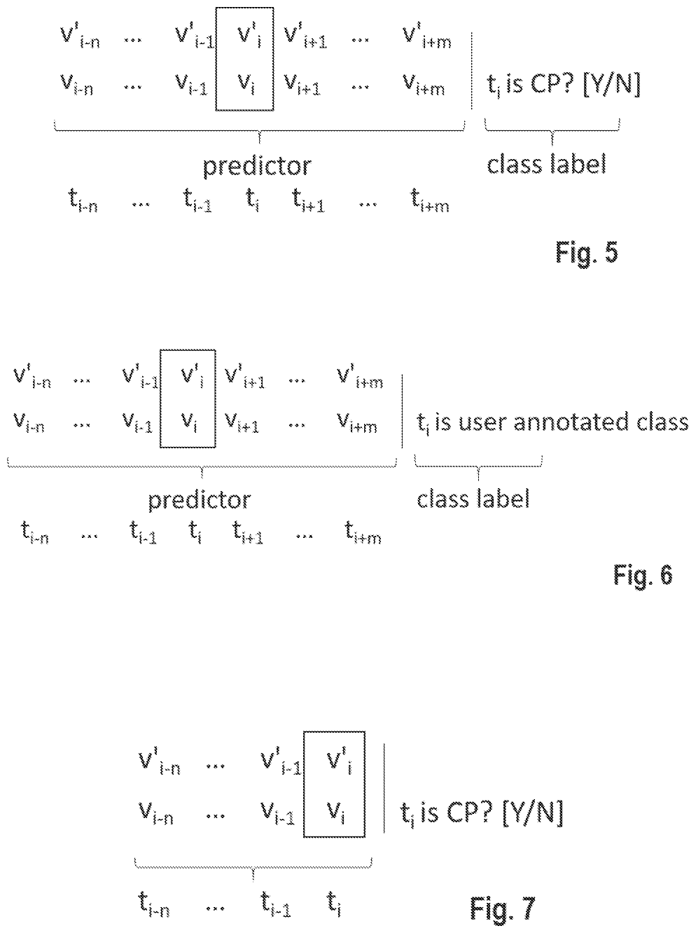

Referring to machine-learning based CP selection 141, FIG. 5 shows the structure of a training sample for the machine-learning based offline CPD. The samples described whether a timestamp ti is a change point or not (class label). The values of the reference signal at ti, before ti and after ti constitute the predictor that is used to predict the label of ti. If the human expert(s) provide annotations, these labels can be used to create a multi-class classification problem. Based on the machine-learning based selection, strategies from active learning can be used to decide which candidate change points should be shown next to the human experts. Examples of such strategies are expected model change, expected error reduction, Exponentiated Gradient Exploration for Active Learning, Uncertainty sampling, Querying from diverse subspaces or partitions, Mismatch-first farthest-traversal.

FIG. 3 shows a flow diagram of the methods 141 and 142 of step 140. Method 141 comprises as an example the steps data augmentation 1411, training the CP classifier 1412, applying the CP classifier on candidate CPs 1413, calculating a possible information gain 1414, and selecting next candidate CP to refine 1415 the CP selection. Method 142 comprises the steps extracting shapelets around CPs 1421, searching unrefined CPs for similar shapes 1422, and showing next candidate CP based on similarity 1423.

Referring again to FIG. 2, steps 130 and 140 are part of an iterative process, in which the human expert(s) verify and refine an increasing number of CP changes. Once a threshold of the number of verified change points is achieved and the machine-learning algorithms meet one or several performance thresholds (e.g. based on accuracy, recall, and precision) the iterative process stops and the active learning phase is finished, and the method 100 proceeds to block 400 in FIG. 4 comprising the steps 150, 160, 170, 180, and 190.

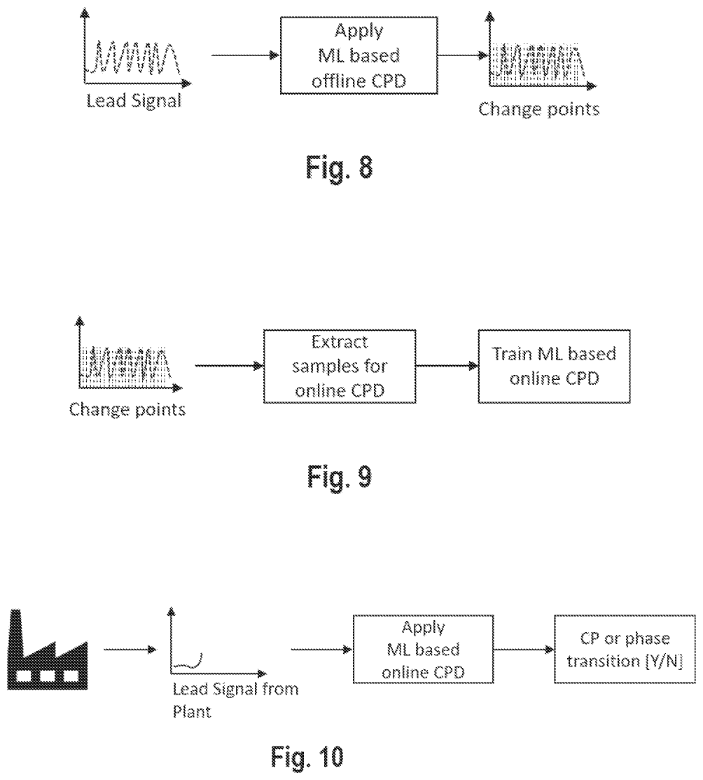

In step 150, as illustrated in FIG. 8, all ti are classified by the model learnt by the active learning framework showed in FIG. 2 (supervised). The learnt model from active learning is used to classify all timestamps ti as change points or not-change points. The input to the model learnt by the active learning framework are the predictors described in FIG. 5 for each ti. This step will produce a list of binary variables of length m-n denoting whether ti is a change point. Additionally, or alternatively, the user may label the timestamps with annotations, as depicted in FIG. 6.

In step 160, a training set of supervised online CPD is created. The previous step created a label for each ti. In this step, this label is used to train a supervised online CPD. FIG. 7 shows the structure of a sample for training the online CPD model. It is very similar to the offline step but does not use data with time-stamps larger than ti (if the application allows for a certain delay in detection, also time-stamps larger than ti might be included). The labels in the samples are here produced by the offline algorithms and not the human expert(s). Step 160 and the following step 170 are illustrated in FIG. 9.

In step 170, as illustrated in FIG. 9, an online model is trained in a supervised manner. In this step a classification algorithm is trained with the training data set created in the previous step. The machine learnt model will be able to perform an online CPD.

In step 180, as illustrated in FIG. 10, CPs or phase transitions are detected using trained online machine-learning models. That is, the machine-learning based online CPD is applied to, for example, the lead signal from the plant.

In step 190, a leveraging of the transfer learning for CPD is performed. That is, the learnt models are transferred to other processes in the plant.

The presented method and system are applicable for online CPD such as detecting transitions between phases in a batch production process, detecting changes in process behavior automatically in order to inform the operator, pre-processing for pattern recognition as well as for offline CPD such as pre-processing data for machine-learning or for signal data search, e.g., to segment the continuous data into segments that can be compared). The change points detected by this invention are further an important basis for further analysis for example with multivariate algorithms like Multivariate Principal Component Analysis (MPCA).

Other variations to the disclosed embodiments can be understood and effected by those skilled in the art in practicing the claimed invention, from the study of the drawings, the disclosure, and the appended claims. In the claims the word “comprising” does not exclude other elements or steps and the indefinite article “a” or “an” does not exclude a plurality. A single processor or other unit may fulfill the functions of several items or steps recited in the claims. The mere fact that certain measures are recited in mutually different dependent claims does not indicate that a combination of these measures cannot be used to advantage. A computer program may be stored/distributed on a suitable medium such as an optical storage medium or a solid-state medium supplied together with or as part of other hardware, but may also be distributed in other forms, such as via the Internet or other wired or wireless telecommunication systems. Any reference signs in the claims should not be construed as limiting the scope of the claims.

The method may be applied in any automation system, e.g., in the field of process automation or robotics.

According to an embodiment, the step of detecting CPs using the trained online ML system includes recording live data in the automation system and detecting CPs in the live data and, upon detecting a CP, triggering an action.

As already mentioned, live data is currently generated data of e.g. one or more processes or sensors. The data is collected and recorded and input to the online ML system. When a CP is detected, actions such as, for example, changing the alarm settings of the system or notifying an operator about a change in the process may be performed.

According to an embodiment, the offline signal is represented by samples of the signal. The samples are samples inside a random time-window, and the candidate CPs are selected from the samples contained in the random time-window. In other words, time windows are created randomly, i.e., for example start and stop times are random, or start time is random and the time span of a time window is fixed, and the candidates are samples inside these time windows. As explained above, the signal is a reference signal, and there may be several reference signals. The randomization may be performed across all reference signals.

According to an embodiment, the samples of each time window are processed by a first algorithm and a second algorithm, and both algorithms provide candidate CPs.

In general, for each time window, a plurality of algorithms may be applied, and from each of these time window—algorithm combinations, none, one, or more than one candidate CPs may be obtained.

According to an embodiment, each algorithm is varied by parameters, and the samples of each time window are processed by each varied first algorithm and each varied second algorithm, such that candidate CPs are obtained by each of the varied first algorithm and each varied second algorithm. The terms “first” and “second” algorithms are representative for a plurality of algorithms. By varying parameters of an algorithm, a further dimension is provided for the creation of candidate CPs. All candidate CPs identified in this way are provided to the selection process.

According to an embodiment, the selection out of the candidate CPs is according one of the following: (i) selecting the CPs randomly out of the candidate CPs, (ii) defining a sliding time-window length smaller than the time-window, summing up the number of CP candidates detected across all CP algorithms, and selecting windows with a high sum are selected, (iii) using all the CP candidates or a random sample of all candidates and time-windows without CP candidates as input to a machine-learning classification, (iv) correlating the candidate CPs with a batch event log, and/or (v) correlating multiple signals or several process variables. Each of these possibilities may be used entirely independent of each other.

The option “selecting the CPs randomly” may be understood to be a randomly selection inside one time-window and/or across all time windows. Depending on the performance of the unsupervised CPD algorithms, this might yield many CP candidates that are actually not CPs. This is actually desirable, because in the later process the machine-learning is supposed to learn from positive and negative examples to differentiate CP from not CPs.

The option “defining a sliding time-window length” may be implemented such that the sliding window is smaller than the time-window. The number of CP candidates found across all CP algorithms is summed up and windows with a high sum are selected. The user may be presented with such windows that contain a high number of CPs. As a general rule, the size of the time-window length n should be much smaller than the time-window length that the CP algorithms use internally. Ideally, the window length n should be chosen in such a way, that the user is indifferent where exactly in the time-window the change point is located. Thus, the value n is application dependent and needs to be defined by the user or another expert.

An example of the option “using all the CP candidates or a random sample of all candidates and time-windows without CP candidates as input to a machine-learning classification” is a time-series classification with a recurrent neural network (RNN) allowing for varying sample length. The idea is that the classifier deals with the noisy input and focusses on such change point characteristics, where the unsupervised algorithms agree. The selection is then done based on the labels assigned by the machine-learning classification.

The option “correlating the candidate CPs with a batch event log batch” may be applied when the batch event log is available. In this case the candidate CPs can be associated with the batch events by matching their time stamps. If a batch event can be connected to at least one CP in each batch run, then the corresponding CPs can be chosen as candidates and can be annotated with the corresponding batch events. Similarly, CPs that cannot be associated with any known batch events will be kept as candidates. It is possible for these CPs to be anomalies that do not originate from any operations or set point changes. In order to further assist the user, the batch event can be visualized along with the candidate CPs so that the user can make more informed decision to accept or to reject the candidate CPs.

Although the CPs are detected for individual signals, the candidates of CPs can be determined using multiple signals, which is one further option. A CP can be considered as a candidate if several process variables have the same CP or adjacent CPs in a very small time window. This can be done by visualizing and clustering the CPs of several variables with respect to their time stamps. Moreover, the rule of inspecting multiple variables can be specified by the user, for example several set points in the process are changed at the same time and a common CP for these process variables will be a candidate.

According to an embodiment, after the step of supervised training an offline ML system, a refining of the CP selection is performed by the user and parameters of the algorithms are tuned according to or based on the refinement.

For example, a change point is deleted or added, or its position is changed. Further, the change point is annotated, for example for annotating a change from batch phase A to batch phase B or change from steady state to transition due to load change. In this step, parameters of the CPD algorithm may be tuned so that the algorithm results in fewer or more CPs. Thus, the method provides an incorporation of additional user annotation for change points to enable phase or episode detection and allows for easily tune tuning unsupervised CPD algorithms for refinement of change points.

The output of several CPD algorithms can be presented to the user and the user can choose the best one.

According to an embodiment, optionally one or a combination of the following static rules is added to the training step of training an offline ML system refining CPs from the selected CPs using a supervised machine learning method. As a first refinement rule option, CPs from candidates of unsupervised algorithms having best agreement-ratio are selected. As a second refinement rule option, the selection problem is modelled as binary classification problem of a supervised classification. As a third refinement rule option, characteristics of a sequence of the reference signal in a time span before and after a CP are determined, and the characteristic of the sequence is compared to the characteristics of a sequence of the reference signal in a time span before and after a further CP and selecting CPs that show similarity. As a fourth refinement rule option, a k-means clustering algorithm is applied to a time series, the time series is labeled, and cluster points of time series similar to the labelled time series are selected. As a fifth refinement rule option, a classifier is trained to decide whether a timestamp ti is a change point or not, and the change point is selected based on the decision.

Each of these options may be applied alone and independently of another of these options or in combination with one or more other options.

The first refinement rule option addresses an algorithms-based selection that is based on the agreement of the expert with the unsupervised CPD algorithms. An example of policy is to capture the ratio of agreement per algorithms and favor candidates of change points from such algorithms that often produce candidates accepted by the user.

The second refinement rule option addresses also an algorithms-based selection, in which the selection problem is modelled as binary classification problem, i.e., whether the user accepts the candidates as change point or not. Here, classification algorithms can use the reference signals as additional predictor output and can incorporate the data characteristics into the decision.

The third refinement rule option relates to the usage of similarity measures to find likely true change points from candidate change points identified from unsupervised CPD. The similarity-based selection takes an extract of the reference signal between two (tcpi until tcpi+1) or three (tcpi until tcpi+2) change points. The start and end change points then define a slice of the signal matrix [timestamp t, value v] with tcpi<t<tcpi+1 (tcpi<t<tcpi+2 for two subsequent change points). The method then searches similar sequences in the reference signal (tcpi′ until tcpi′+2 or tcpi′ until tcpi′+2) in the set of candidate change points to find similar types of shapes and transitions that thus presumably capture a similar effect in the production process.

The fourth refinement rule option is a variant of the similarity-based selection described above. This selection might leverage (automatic) clustering algorithms, especially k-means or its variants. One implementation might use k-means or its variants with number k=2 to achieve a clustering with 2 clusters. In difference to classical k-means or its variants one cluster centroid would be fixed to a labeled change point (or labeled not-change point). The result would be two groups of time-series examples: one group similar to the labeled time-series and the other dissimilar. The user would be presented the similar group along with the already labeled change point and ask to confirm the label. The similar time-series might be presented in batches to the user, from most similar to less similar. Batches might be fixed sizes (e.g., five sequences at ones) or based on percentiles of similarity. Once the user stops labeling the sequences with change points, the process of presenting the label can be stopped. In this way, the user can label large amounts of sequences at once. Another variant of using clustering algorithms is to start with more than one labeled sequence and increase the number of k clusters to the number of labeled sequence or slightly bigger. As pre-processing steps, labeled sequences that are very similar, which may be detected for example based on threshold or based on being each other closest neighbor according, are forced to stay in the same cluster. Other clustering algorithms like DBSCAN can be modified in a similar way by replacing the random initialization with initialization around already labeled points.

The fifth refinement rule option relates to a machine-learning-based selection: In this case, a binary classifier is trained on the refined examples, and optionally examples labeled by one or both of the previous methods, to decide if at a given time t there is a change point in the reference signals.

According to an embodiment, the refining comprises storing the method and the parameters during performing the refining steps, therewith forming a learnt model. This step yields and saves the result of the previous steps, which is a learnt offline model.

According to an embodiment, in a step after the step of training, supervised, an offline machine-learning, ML, system to refine CPs from the selected CPs, the step classifying all ti using the learnt model is performed.

In a step after the step of training, supervised, an offline machine-learning system, the step creating a training set is performed. Where the labels for each timestamp is used to train a supervised online CPD.

According to an embodiment, in a step after the step of creating a training data set for an online ML system and before 180, the step training an online model is performed. In this step a classification algorithm is trained with the training data set created in the previous step. The machine learnt model will be able to perform an online CPD.

According to an embodiment, in a step 190 after step 180 the step transferring the learnt online model and the learnt offline model for further processes is performed. Both the machine-learning models for offline CPD and online CPD might be used across different industrial processes. The trained model from industrial process A (with learnt parameters such as weights) are used as starting point for training the models for process B. As precondition, the number of leading signals in A and B should be the same. The initialization of parameters from training in process A likely constitutes a better starting point for training compared to a random initialization of parameters, which is the usual way of starting a machine-learning process. As a consequence, the learning will require fewer optimization steps and less labeled data to achieve an acceptable performance.

According to a further aspect, a controller is provided that is configured to perform the steps of the computer-implemented method. The controller may comprise circuits without programmable logics or may be or comprise a micro controller, a field programmable gate array (FPGA), an ASIC, a Complex Programmable Logic Devices (CPLD), or any other programmable logic devices known to person skilled in the art.

Further, a computer program element and computer readable medium may be provided. The computer program element is the implementation of methods described herein. The computer readable medium stores the computer program element. The computer program element may be part of a computer program, but it can also be an entire program by itself. For example, the computer program element may be used to update an already existing computer program to get to the present invention.

According to a further aspect, an industrial process system comprising such a controller is provided.

According to a further aspect the use of a controller such a controller in an industrial process system is provided.

These and other features, aspects and advantages of the present invention will become better understood with reference to the accompanying figures and the following description. Identical or equivalent elements are in principle provided with the same reference signs.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented method for detecting change points (CPs) in a signal of an automation system, comprising:
in an offline learning phase,
detecting unsupervised candidate CPs on at least one offline signal using unsupervised detection method;
selecting CPs from the candidate CPs and providing the selected CPs to a supervised process;
training, supervised, an offline machine-learning, ML, system to refine CPs from the selected CPs using a supervised machine learning method;
creating a training data set using the offline ML system for an online ML system by projecting the refined CPs on the signal;
training, supervised, the online ML system using the created training data set; and after the offline learning phase, and
detecting CPs using the trained online ML system.

2. The computer-implemented method according to claim 1, wherein the step detecting CPs using the trained online ML system includes recording live data in the automation system and detecting, by using the online ML system, CPs in the live data and, upon detecting a CP, triggering an action.

3. The computer-implemented method according to claim 1, wherein the offline signal is represented by samples of the signal, the samples are samples inside a random time-window, and the candidate CPs are selected from the samples contained in the random time-window.

4. The computer-implemented method according to claim 3, wherein the samples of each time window are processed by a first algorithm and a second algorithm, and both algorithms provide candidate CPs.

5. The computer-implemented method according to claim 4, wherein each algorithm is varied by parameters, and the samples of each time window are processed by each first algorithm and each varied second algorithm are varied, such that candidate CPs are obtained by each of the varied first algorithm and each varied second algorithm.

6. The computer-implemented method according to claim 1, wherein the selecting CPs from the candidate CPs comprises one of the following methods:
selecting the CPs randomly out of the candidate CPs;
defining a sliding time-window length, summing up the number of CP candidates detected across all CP algorithms, and selecting windows with a high sum are selected;
using all the CP candidates or a random sample of all candidates and time-windows without CP candidates as input to a machine-learning classification;
correlating the candidate CPs with a batch event log;
correlating multiple signals or several process variables.

7. The computer-implemented method according to claim 1, wherein after step of training, supervised, an offline ML system, a refining of the CP selection is performed by the user, and wherein parameters of a model are tuned according to the refinement.

8. The computer-implemented method according to claim 1, wherein one or a combination of the following static rules is added to the step of training, supervised, an offline machine-learning, system:
selecting CPs from candidates of unsupervised algorithms having best agreement-ratio;
modelling the selection problem as binary classification problem of a supervised classification;
determining characteristics of a sequence of the reference signal in a time span before and after a CP, comparing the characteristics to the characteristics of a sequence of the reference signal in a time span before and after a further CP and selecting CPs that show similarity;
applying a k-means clustering algorithm to a time series, labeling the time series and selecting cluster points of time series similar to the labelled time series;
training a classifier, deciding whether a timestamp ti is a change point or not, and selecting the change point based of the decision.

9. The computer-implemented method according to claim 1, wherein the refining comprises storing the method and the parameters during performing the refining steps therewith forming a learnt offline model.

10. The computer-implemented method according to claim 1, wherein, in a step after the step of training, supervised, an offline machine-learning, ML, system to refine CPs from the selected CPs, the step of classifying all ti using the learnt model is performed.

11. The computer-implemented method according to claim 1, wherein, in a step after the step of creating a training data set for an online ML system, the step of training an online model is performed.

12. The computer-implemented method according to claim 1, wherein, in a step after step of detecting CPs using the trained online ML the step of transferring the learnt online model and the learnt offline model for further processes is performed.
